(19) United States
(12) Patent Application Publication
(10) Pub. No.: US 2016/0311506 A1
(43) Pub. Date: Oct. 27, 2016

(54) TEMPORARY POST BRACE FOR WATER ACTIVITIES

(71) Applicant: William Hervey, Columbia, MO (US)

(72) Inventor: William Hervey, Columbia, MO (US)

(21) Appl. No.: 14/752,855

(22) Filed: Jun. 27, 2015

Related U.S. Application Data
(63) Continuation-in-part of application No. 14/545,312, filed on Apr. 22, 2015, now abandoned.

(51) Int. Cl. B63B 29/00; F21V 21/00; F21L 4/08

(52) U.S. Cl. CPC B63B 29/00; F21L 4/08; F21V 21/00

(57) ABSTRACT

A post brace that is used to temporarily support solar lights on a boat made of a water resistant shell and filled with beads is disclosed herein. The post brace can support a variety of solar light posts and other posts, such as flag posts.

### CROSS-REFERENCE TO RELATED APPLICATION

This application claims priority to U.S. Non-Provisional Application Ser. No. 14/545,312, filed on Apr. 22, 2015, which is incorporated herein by reference in its entirety.

### FIELD OF INVENTION

Embodiments of the current invention relate to the mechanical arts and more specifically, boating products.

### BACKGROUND OF INVENTION

Many boaters enjoy anchoring their boat for the night, which for safety reasons, requires the use of an anchor light. An anchor light that receives its electricity supply from the boat runs the risk of causing a dead battery and an anchor light that receives its electricity supply from a generator will create harmful fumes. However, a solar boat light does not have this problem, and solar yard lights are readily available, but most boats do not have a place to brace a solar yard light.

Boaters cannot easily rest a light on a boat that is anchored because periodic waves or other perturbations in the water can cause the light that is simply resting on the boat to fall to a level where it cannot be seen by other boaters.

A need exists for boaters to be able to easily and selectively place an anchor light on a boat to alert other boaters that a boat is anchored. The anchor light must stand in a fixed position while gentle waves or water perturbations rock the boat.

The design should be water resistant and inexpensive.

### SUMMARY OF INVENTION

The following disclosure describes an apparatus that allows users to selectively place an anchor light on varying surfaces and the anchor light, although not permanently fixed to the boat, will be capable of withstanding most waves and typical perturbations caused by people moving on a boat. The apparatus is a post brace which can support a wide range of solar light posts.

The apparatus weighs more than two pounds but less than fifteen pounds and will be substantially cone shaped. In one embodiment, favored for ease of manufacture, the post brace consists of a cone shaped apparatus wherein the length of the sides is about equal to the diameter of the base. In another embodiment, the sides of the apparatus will be slightly curved, so that more weight is located lower as compared to a perfect cone. In this embodiment, there is a skinnier neck when compared to a perfect cone.

The center of the cone is a hollow opening capable of receiving a light fixture. The hollow opening is substantially cylindrical and makes the cone into a volcano shape. In one embodiment, the light fixture is a solar yard light that can be staked into soil. In one embodiment, the light fixture is a solar light.

The cone is comprised of a shell made of a material that is water resistant and provides a sufficient coefficient of friction. In one embodiment, the shell material is marine grade vinyl upholstery commonly used to upholster boat seats. Inside the shell are beads that provide the cone with weight and conformability. The conformability allows the cone to fit snugly around various sizes of light posts and it also allows the bottom of the cone to maximize surface area contact on uneven surfaces that the cone may rest upon.

### BRIEF DESCRIPTION OF DRAWINGS

FIG. 1 shows the post brace for boats with beads;

FIG. 2 shows one piece of the post brace;

FIG. 3 shows another piece of the post brace;

FIG. 4 depicts putting the pieces of the post brace together;

FIG. 5 shows the post brace in an intermediate manufacturing form.

FIG. 6A shows the post brace over an exemplary surface.

FIG. 6B shows the post brace over another exemplary surface.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

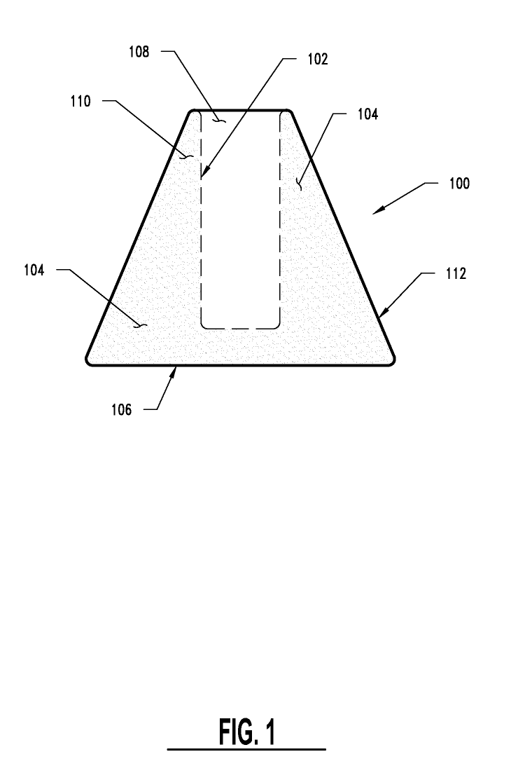

FIG. 1 shows a temporary post brace 100 that can effectively conform to effectively hold posts of varying diameters, and to conform effectively to surfaces by holding on uneven surfaces and is ideal for bracing solar lights or flags on boats, making it easy to temporarily set up an anchor light or other post. The post brace 100 effectively conforms because it consists of a shell material 112 that is filled with beads 104, except for an empty cylinder 108 that is substantially void of beads. Not only do the beads 104 provide weight, but the sides 102 of the cylinder 108 will hold a post that is put into the cylinder 108 as the upper beads 110 push down on the lower beads 104. Similarly, the bottom 106 of the post brace conforms to different surfaces because the beads have some freedom of movement.

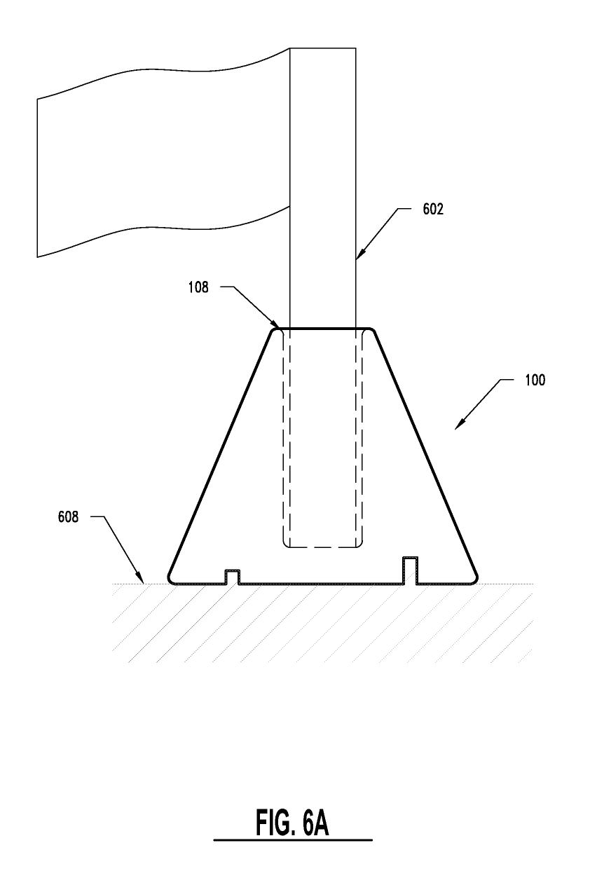

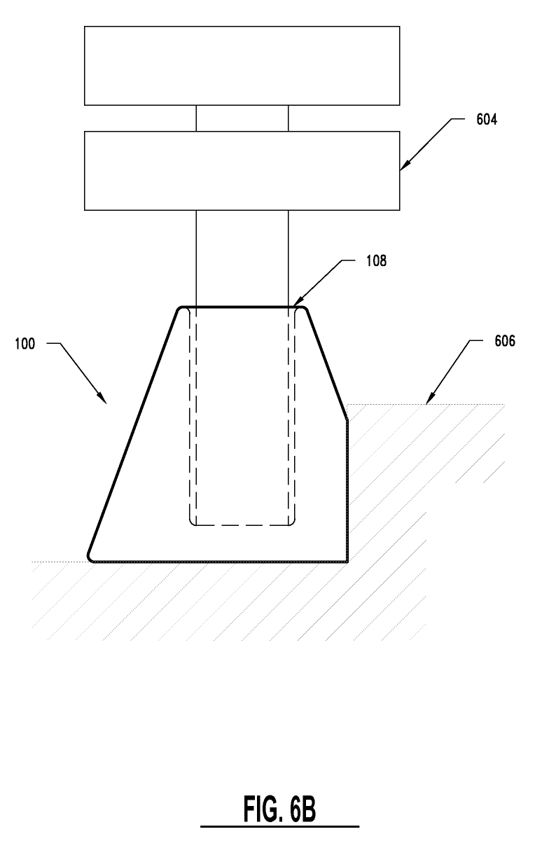

The capacity of the post brace to conform is shown in FIGS. 6A and 6B. The post brace 100, can effectively conform to hold a solar light on top of a two inch diameter post 604, or a flag with a one half of an inch diameter post 602. The post brace 100 can also effectively conform to different surfaces of a boat 608 or 606 as well as other surfaces. Those surfaces include patios, decks, docks, outdoor stairs, RVs and other outside areas, particularly hard surfaces that are not connected to an attractive supply of electricity.

Beads 104 are used to provide conformability and mass. The beads can be any inexpensive, environmentally friendly, cleanable material of suitable density for bracing a solar yard light that is ideally sized and size distributed. Gravel or pebbles are an ideal material, wherein the pebbles are generally ⅛″ to ⅜″ in diameter. Pea gravel of that size is the preferred material. Sand and crushed stone are suitable substitutes. Ideal size is ⅛″ to ⅜″. Other filling materials include beads of polymer, metal, wood, sand or waste material.

The shell material 112 is ideally water impermeable and resistant to sun, and is also inexpensive and effective at holding various surfaces on a boat. In one embodiment, the shell material is also capable of displaying logos 210 or other designs or words and is ideally cleaned with the same cleaning supplies used to clean boats. Vinyl, as is used in boat upholstery, is an ideal material.

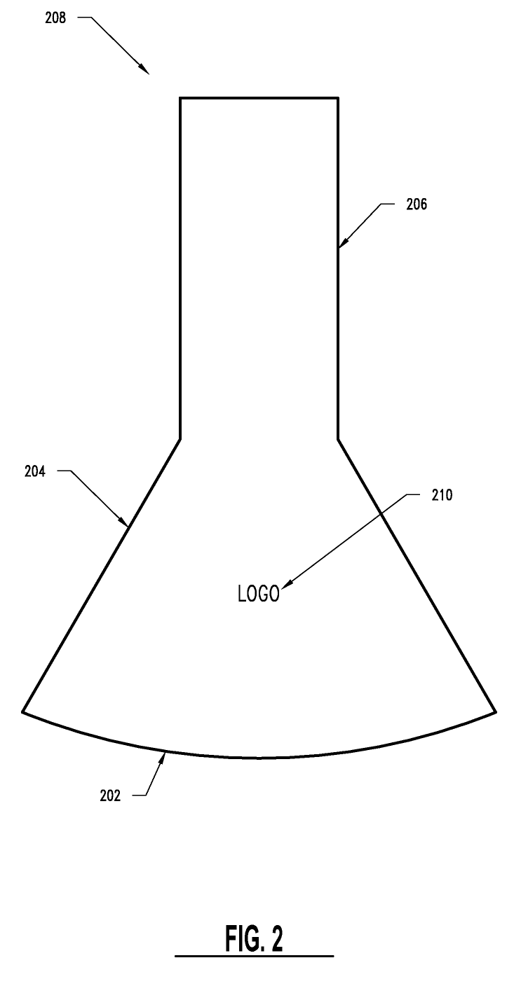

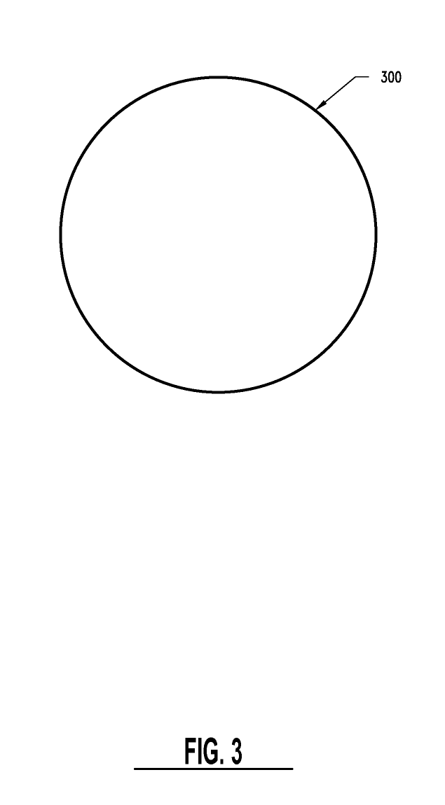

FIG. 2 shows a first piece 208 of the shell. In one embodiment, the preferred shape is substantially a triangle 204 with a curved base 202 substantially a rectangle 206 on top. In one embodiment, each post brace will consist of two pieces like the first piece 208, which will be fused together and fused to a piece that is substantially circular 300, which is shown in FIG. 3. The triangle does not need to be one integral piece with the rectangle. Instead, the two can be fused together.

The sides of the triangle 204 are substantially equal in length. The curved base 202 should be substantially equal to half the circumference of the circular piece 300. However, some extra length on the curved bases 202 will be required to fuse the first triangle 204 with a corresponding mirror image, a second triangle. If stitching is used, there must be enough extra length on the curved base 204 and the mirror image so that the triangles can overlap over the stitch.

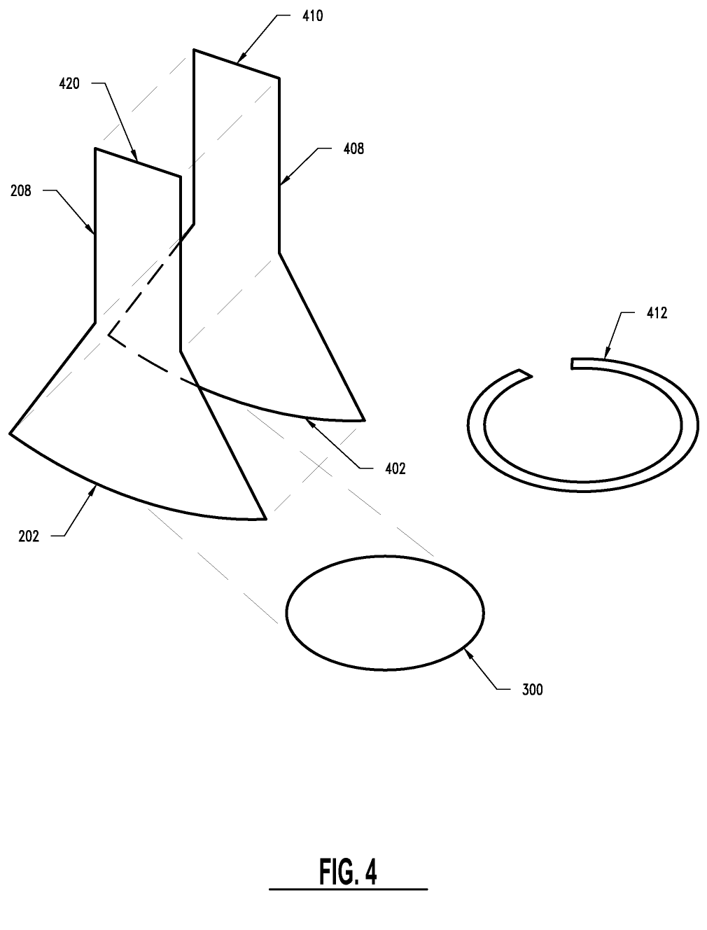

FIG. 4 illustrates how the first side piece 208 fits to the second side piece 408 and how both fit to the circular piece. Each side of the first piece 208 is fused to the mirror image sides of the second piece 408 and the curved bases 202 and 402 are fused to the circumference of the circular piece 300. The curved bases 202 and 402 should be consistently fused to the circular piece 300 so as to produce an even base and so the curved bases 202 and 402 form a consistent circle.

In one embodiment, the curved bases 202 and 402 are fused to the circular piece 300 with a strip 412. The strip 412 is fused at one side to the curved bases 202 and 402 and the other side of the strip 412 is fused to the circular piece 300.

The tops of the rectangles 410 and 420 will not be fused. Instead, the pieces form an enclosure that is open at the top. Since the three pieces are all fused together at all points except for a narrow opening on a neck, the resulting object is substantially balloon-shaped with a long neck, although as used herein the balloon has a flat end with an opposing neck that is about as long as the balloon portion is from the flat end the where the neck begins. The balloon portion is preferably cone shaped, but could also be in a half sphere.

The shapes are ideally sheets of vinyl, but sheets of other water impermeable materials are also suitable. Marine grade vinyl is preferred, but other flexible materials that are water impermeable, economical, are able to display logos and words. Leather and synthetics are also acceptable.

The strip 412 also acts as a bumper, so the material requirements are slightly different. The ideal strip 412 materials is a wear resistant marine grade polymer, but other flexible, water impermeable, weather resistant, shear resistant polymers are also suitable. Ideally, the strip will resist wear and provide more strength in the stitching than the shell.

The shapes can be fused together by stitching, but other fusing methods are also suitable, such as adhesives and stapling.

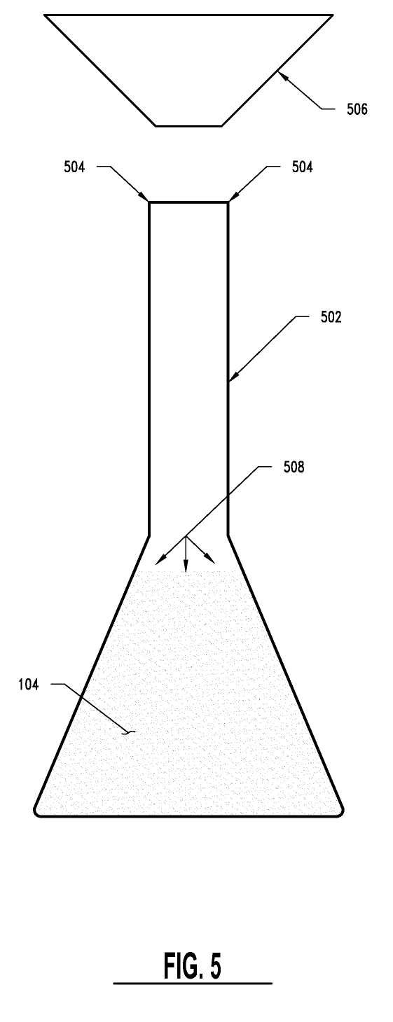

The finished post brace 100 includes beads. As illustrated in FIG. 5, the beads are loaded into the open neck 502. The loading ideally occurs through a hopper 506. The hopper 506 includes nozzles, funnels, and similar devices. In one embodiment, after the beads 104 are loaded into the support brace and the top of the neck 502 has been fused to fully enclose the apparatus, the neck 502 is pushed down 504 and the beads are pushed down and to the sides 508 until the post brace 100 appears as in FIG. 1. Various devices can be used to push the neck 502 into the brace 504 and to push the beads down and outward 508, including a piston or a plunger. In another embodiment, a hollow cylinder could be placed into the post brace and the beads inside the cylinder could be removed to make way for the neck 502 as it is pushed into 504 the post brace. The top of the neck 502 can be fused by sewing, stapling, or with an adhesive. The post brace should be filled to within about one inch from the bottom of the neck 502.

In one embodiment, the preferred weight of the post brace is between 2 and 4 pounds. However, larger post braces could be made for tall anchor lights (3 feet or higher).

FIGS. 6A and 6B illustrate how the post brace is used by two examples. The shaft 108 will collapse on posts of varying diameter or shape so that it can hold a ski flag 602, wherein the post diameter is one half of one inch as shown in FIG. 6A. Or the shaft can expand to hold a solar yard light 604, wherein the post diameter is two inches as shown in FIG. 6B. The beads in the support brace provide the conformability to hold posts of varying diameters.

The beads also enable the post brace to sit snugly to varying surfaces such as surfaces 608 and 606 shown in FIG. 6A and FIG. 6B. The post brace 100 provides stability in a wide range of surfaces and for a wide range of post diameters.

I claim:

1. A post brace comprising
a water resistant shell
wherein the shell is filled with a filling material
and wherein the center of the post brace has a hollow cylinder shaped receptacle.

2. The post brace of claim 1, wherein the post brace is substantially cone shaped having a nose end and a flat end, with the opening to the hollow cylinder on the nose end of the cone.

3. The post brace of claim 1, wherein the filling material is pea gravel.

4. The post brace of claim 1, wherein the shell is substantially balloon-shaped

5. The post brace of claim 4, wherein the shell consists of a water impermeable material.

6. The post brace of claim 4, wherein the shell is made from three pieces cut from vinyl sheets, and wherein the sides of the three pieces are stitched together.

7. A method of manufacturing a light fixture support brace comprising the steps of
cutting sheets of impermeable material to obtain three separate pieces of the sheet,
fusing the ends of the three separate pieces together to form a shell that is substantially balloon-shaped having a balloon section and an open neck,
filling the shell at the open neck with a filling material, and

8. The method of claim 7, wherein the three separate pieces consist of
a first piece that is a triangle having a curved base and connected to a first rectangle above it,
a second piece that is a triangle having a curved base and connected to a second rectangle above it, and
one substantially circular piece

9. The method of claim 8, wherein the first piece is substantially a mirror image of the second piece.

10. The method of claim 7, wherein filling the shell further comprised dropping filling material from a hopper into the neck so that the filling material fills up the larger portion of the shell until the filling material reaches about one inch from the bottom of the open neck.

11. The method of claim 7, further comprising the step of placing a post of a solar light into the hollow cylinder.

12. The method of claim 7, further comprising the step of folding the open neck into the balloon section so that the balloon section is not visible to create a hollow cylinder within the balloon section.

13. A mobile light fixture comprising
a solar light, and
a detachable weighted base that is weighted to hold the solar light and to prevent it from tipping over when it leans more than 30 degrees from vertical.

14. The mobile light fixture of claim 13, wherein the weighted base is substantially cone shaped.

15. The mobile light fixture of claim 14, wherein the weighted base is further comprised of a shell and a filling material.

16. The mobile light fixture of claim 15, wherein the filling material consists of pea gravel.

17. The mobile light fixture of claim 15, wherein the shell is comprised of a flexible and water impermeable material.

18. The mobile light fixture of claim 13, wherein the mobile light fixture further comprises a bumper surrounding the bottom of the base.

19. The mobile light fixture of claim 13, wherein the solar light is a solar yard light.

20. The mobile light fixture of claim 15, wherein the filling material is sand.
